(19) United States
(12) Patent Application Publication
(10) Pub. No.: US 2020/0279395 A1
(43) Pub. Date: Sep. 3, 2020

(54) METHOD AND SYSTEM FOR ENHANCED SENSING CAPABILITIES FOR VEHICLES

(71) Applicant: CEPTION TECHNOLOGIES LTD., Jerusalem (IL)

(72) Inventors: YOSSEF ISRAEL BUDA, KFAR-ADUMIM (IL); TAL ISRAEL, MAZKERET-BATYA (IL)

(73) Assignee: CEPTION TECHNOLOGIES LTD., Jerusalem (IL)

(21) Appl. No.: 16/763,984

(22) PCT Filed: Nov. 14, 2018
(86) PCT No.: PCT/IB2018/058959

§ 371 Date: May 14, 2020

Related U.S. Application Data
(60) Provisional application No. 62/585,566, filed on Nov. 14, 2017.

(51) Int. Cl. G06T 7/73; G06T 3/40; G06T 3/00

(52) U.S. Cl. CPC G06T 7/73; G06T 3/40; G06T 2207/20132; G06T 2207/10044; G06T 2207/10132; G06T 3/0093

(57) ABSTRACT

Methods and systems for accurately determining positions of the system itself, or a vehicle, in which the system is used, operate by obtaining a plurality of first patterns, each of the first patterns associated with a position; establishing a system position; acquiring at least one second pattern proximate to the position of the system; and, matching the at least one second pattern to at least one of first patterns, to determine a subsequent system position.

### CROSS REFERENCE TO RELATED APPLICATION

This application is related to and claims priority from commonly owned U.S. Provisional Patent Application Ser. No. 62/585,566, entitled: Method and System for Enhanced Sensing Capabilities for Vehicles, filed on Nov. 14, 2017, the disclosure of which is incorporated by reference in its entirety herein.

### FIELD OF THE INVENTION

The present invention is directed to systems and methods for smart mobility systems, such as autonomous vehicles at various levels of autonomy, and, also for Advanced Driver Assistance Systems (ADAS) for situations where driving is performed by a human driver.

### BACKGROUND OF THE INVENTION

Automated Driving Systems (ADS) require exact positional data and the ability to understand the surroundings where the system is operating (scene understanding). Integration of perceptional data with further data, such as the conditions of the road and surroundings along the way and more, enables an ADS to carry out the necessary processes of motion and control.

Currently existing systems of various types, such as Global Navigational Satellite Systems (GNSS) based on various technologies, can provide positional information. However, GNSS systems do not provide the precise and continuous solution that ADS requires, and these systems suffer from various limitations because of failure or inconsistent satellite reception.

Another family of solutions is the inertial navigation systems (INS). Like the other aforementioned systems, these systems suffer from inaccuracies and drifting. In addition, they are too expensive for use in mass produced vehicle systems.

Therefore, in recent years, various methods have been under development for pinpointing position by means of environmental factors and data. These methods provide global positioning by use of a database that contains High Definition (HD) mapping data and environmental elements such as road signs, landmarks, etc. During vehicle travel, various sensors identify these elements, and, from matches between the elements, a global positioning solution can be achieved for the vehicle. These systems, being based on identification of elements in the surroundings, suffer from a number of disadvantages. Elements in the surroundings may change over time, requiring the database to be continually updated. Moreover, in most cases, the view of the surroundings through one sensor or another is subject to various disruptions that may prevent proper identification, such as blockage by a vehicle ahead or sensitivity to various lighting and weather conditions that may prevent real-time identification in certain circumstances.

Another approach relies on the use of a sensor, such as a camera aimed at the road surface, and on global anchoring based on discerning and saving features. When the journey is made repeatedly, the entire image can be processed, the features can be isolated, and the position can be extracted accordingly. However, this approach has a number of disadvantages. For example, there are problems depending on the extraction of features for matching. Some of the prominent features that the method relies on are temporary by nature, such as puddles of oil/water, cracks, holes, and other road defects. The result is that over time, those features change in the real world and therefore the database must be updated relatively frequently. Another disadvantage is that significant computing resources, including calculation power and storage, are required for processing the image received from the camera, searching through it, and extracting the features for the solution, so that implementation is a problem on long multi-lane roadways etc.

### SUMMARY

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

The present invention provides a precise, reliable positional solution for vehicles, with continuous accuracy of position (location) determination.

In addition to precise and accurate vehicle positioning, the invention is such that the safety system or ADS provides for mapping of the vehicle's surroundings, including identification of objects and obstacles. The present invention provides systems and methods for understanding the vehicle's surroundings, by constructing a three dimensional (3D) model or map (these terms, model and map used interchangeably herein). The methods and systems of the invention employ sensors, to serve as a source for images from which the 3D maps/models are made. Sensors include, for example, LIDAR scanners (which read reflected laser pulses) representing various technologies, cameras that use structured light projected onto the environment, radar sensors, and cameras, which produce images from which 3D features can be extracted and modeled/mapped by algorithms. Imaging techniques range from use of a number of cameras that provide varying of points of view (much like human stereopsis) to training a moving camera on a single target (structure from motion).

Additional information vital to an ADS, and to a human-piloted system, includes data about the condition of the travel surface. There are disclosed systems and methods intended to provide information about weather, black ice, and more, with a view to obviating danger in troublesome places and circumstances. The systems and methods involve sampling of the travel surface in real time by means of one or more sensors, plus analysis by means of various algorithms for discerning problematic or hazardous situations.

The system of the invention provides a reliable and accurate global positioning solution based on one or more sensors that sample the surroundings in real time and compare them, by means of an innovative method, to patterns or “road codes”, small highly detailed image portions associated with a specific location in space, as taken from an image, or microimages analogous to fingerprints, that have been sampled from various surfaces in the vicinity of the road or from the surface on which the motion is taking place. The method underlying the system minimizes the quantity of processing power and storage space required for its implementation.

The process of data acquisition includes close-up mapping of the travel surface, and it assumes that the vehicle moves on a surface, e.g., a roadway, that makes possible the use of such a system in order to calculate the movement of the vehicle between overlapping frames. This ability makes possible the creation of a dense, reliable 3D map of the surrounding environment that makes the surroundings mappable and understandable.

In addition, this system—which maps the travel surface at high resolution during movement—makes road condition information available by means of advanced machine learning processes.

The system presented here is based on one or more sensors (such as a camera, structured light, imaging radar, LIDAR, ultrasonic, etc.) installed on the vehicle and collecting data from the vehicle's surroundings. The collected data may include the travel surface neighboring the vehicle, among other things.

The one or more sensors allow for the system to perform one or more of:
calculate the vehicle's relative position;
calculate the vehicle's global position by first matching the current frame against a database that contains small surface patterns with global positional tagging attached, and then matching the resulting information to the current image; and,
create a precise and efficient 3D map in high resolution that contains obstacles and objects of various kinds and the characteristic of the road in the near vicinity of the system/vehicle, based on a number of overlapping frames.

The present invention provides a system of establishing position location as part of an iterative process, than minimizes computing resources, by using less computer resources for each subsequent position determination for the system in the vehicle, and hence, the vehicle. With each subsequent position for the system/vehicle being determined, a lesser amount of number of patterns is retuned than previously, as the position is in a smaller range (area or region of interest (ROI)) of locations, with corresponding patterns, than the previous position.

Embodiments of the invention are directed to a method for establishing the position of a system, e.g., the system itself, or the system as an in-vehicle system, so as to determine the position of the of the vehicle. The method comprises: obtaining a plurality of first patterns, each of the first patterns associated with a position; establishing a system position; acquiring at least one second pattern proximate to the position of the system; and, matching the at least one second pattern to at least one of first patterns, to determine a subsequent system position.

Optionally, the method is such that the first patterns are associated with a position by a positional tag.

Optionally, the method is such that the first patterns are obtained from images.

Optionally, the method is such that the first patterns and the at least one second pattern are obtained from images.

Optionally, the method is such that the first patterns and the at least one second pattern are from different sources associated with different entities.

Optionally, the method is such that the matching the at least one second pattern to at least one of first patterns, to determine the subsequent system position, is performed by processes including cross-correlation.

Optionally, the method is such that the images are obtained from one or more of cameras, structured light devices, radar devices, LIDAR devices and ultrasonic devices.

Optionally, the method is such that the images include photographs, radar images, LIDAR images and ultrasonic images.

Optionally, the method is such that the images are from a plurality of viewpoints.

Optionally, the method is such that the images include aerial and satellite images.

Optionally, the method is such that it additionally comprises: storing the obtained plurality of first patterns in storage media.

Optionally, the method is such that the storing the obtained plurality of first patterns in storage media includes populating at least one database with the plurality of first patterns.

Optionally, the method is such that it additionally comprises: storing the obtained plurality of first patterns in storage media.

Optionally, the method is such that the storing the obtained plurality of first patterns in storage media includes populating at least one database with the plurality of first patterns.

Optionally, the method is such that the establishing a system position includes establishing the system position as an approximation of the system position.

Optionally, the method is such that the subsequent system position is established as the system position, and the method additionally comprises: acquiring at least one second pattern proximate to the position of the system; and, matching the at least one second pattern to at least one of first patterns, to determine a subsequent system position.

Optionally, the method is such that the images are filtered to remove temporal elements prior to creating the first patterns and the at least one second pattern.

Optionally, the method is such that the first patterns used in the matching are from a positional range corresponding to the system position.

Optionally, the method is such that the first patterns and the at least one second pattern are taken from planar surfaces in the environment.

Embodiments of the invention are directed to a method for creating a three dimensional map of an area covered by an image. The method comprises: calculating the relative position of at least two frames of an image based on a pattern analysis; and, applying the calculated relative positions of each of the at least two frames to extract a three dimensional map.

Embodiments of the invention are also directed to a computer system for establishing the position of a system. The computer system comprises: a plurality of sensors for obtaining a plurality of first patterns and associating each first pattern of the plurality of first patterns with a position; a storage medium for storing computer components; and, at least one processor for executing the computer components. The computer components comprise: a first computer component for establishing a system position; a second computer component for acquiring at least one second pattern proximate to the position of the system; and, a third computer component for matching the at least one second pattern to at least one of first patterns, to determine a subsequent system position.

Optionally, the computer system is such that the first patterns are associated with a position by a positional tag.

Embodiments of the invention are directed to a computer usable non-transitory storage medium having a computer program embodied thereon for causing a suitable programmed system to establish the position of a system, by performing the following steps when such program is executed on the system. The steps comprise: obtaining a plurality of first patterns, each of the first patterns associated with a position; establishing a system position; acquiring at least one second pattern proximate to the position of the system; and, matching the at least one second pattern to at least one of first patterns, to determine a subsequent system position.

Optionally, the computer usable non-transitory storage medium is such that the first patterns are associated with a position by a positional tag.

Embodiments of the invention are directed to a computer usable non-transitory storage medium having a computer program embodied thereon for causing a suitable programmed system to create a three dimensional map of an area covered by an image, by performing the following steps when such program is executed on the system. The steps comprise: calculating the relative position of at least two frames of an image based on a pattern analysis; and, applying the calculated relative positions of each of the at least two frames to extract a three dimensional map.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary system of the present invention;

FIG. 2 is a diagram of a system for determining global positioning;

FIG. 3 is a diagram of an exemplary distribution of patterns associated with a roadway in accordance with embodiments of the present invention;

FIG. 4 is a diagram of a system for determining relative positioning;

FIG. 5 is a flow diagram of a process performed by the system of FIG. 4;

FIG. 6A is a diagram of a three dimensional (3D) modeling/mapping system;

FIG. 6B is a flow diagram of an example process performed by the 3D mapping system of FIG. 6A; and,

FIG. 7 is a flow diagram of a process performed by the system of FIG. 1.

DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

The present invention provides methods and systems for accurately determining positions of the system itself, or a vehicle, in which the system is used, operate by obtaining a plurality of first patterns, each of the first patterns associated with a position; establishing a system position; acquiring at least one second pattern proximate to the position of the system; and, matching the at least one second pattern to at least one of first patterns, to determine a subsequent system position.

System Architecture

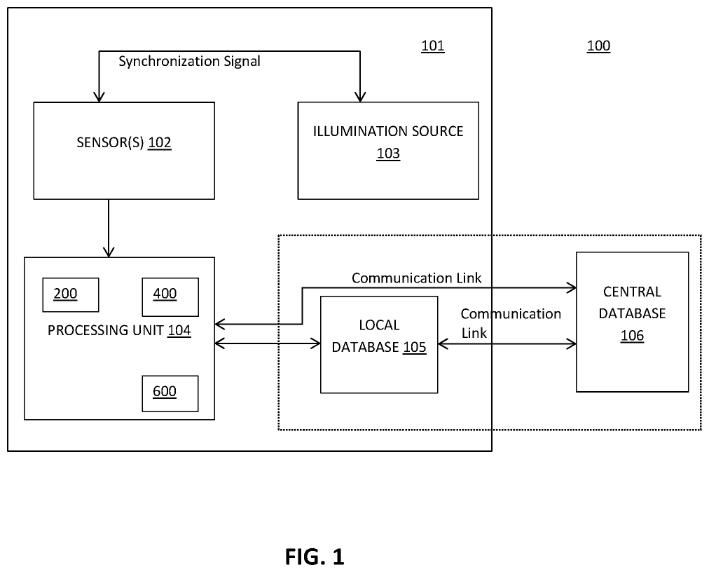

FIG. 1 shows a system 100, for example, a vehicular or in-vehicle system for determining the position of the system 100 itself and/or the vehicle 101 in which the system 100 is used. The vehicle is, for example, an automobile, truck, boat, train, bus, bicycle, motorcycle, airplane, drone, or the like. The system 100 includes one or more sensors 102, such as optical sensors, with short exposure times, or any other sensors by which a clear, sharp image of the vehicle's immediate surroundings may be captured. Other sensors include, for example, cameras, structured light, imaging radar, LIDAR, ultrasonic, and the like, and for example, are installed on the vehicle 101 for collecting data from the vehicle's surroundings. The collected data may include the travel surface surrounding the vehicle, among other things.

An illumination or light source 103, is, for example, optionally integrated into the system 100, to enable it to work in poor lighting conditions or low light, if the sensor 102 is passive (such as a camera). The illumination source 103 may be synchronized with the exposure of the sensor 102 in order to save energy.

The exposure time, the strength of illumination, and other parameters of the sensor(s) 102 may be adjusted in real time to suit, for example, the lighting conditions, the vehicle's 101 speed of travel, and the like.

The data captured by the sensor(s) 102 is, for example raw data, in the form of images and/or frames, where the frames can be frames from the images. This data is passed into the processing unit 104, which, for example, is a computer. A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone, personal digital assistant (PDA), mobile telephone or cellular telephone). The processing unit 104 performs the necessary calculations, including, for example, for position determination of the system 100 and vehicle 101 associated therewith.

For the process of global positioning, or for the process of extracting road parameters as described below, a local database 105, is, for example, integrated on board the vehicle 101. The processing unit 104 links to the local database 105. In addition, the local database 105 is, for example, linked to a central database 106 external to the vehicle 101, by a communication link, including over a communications network, such as the Internet, cellular/mobile communication networks, and the like. Also, the processing unit 104 can link, by a communication link, to the central database 106.

The system 100, for example, via the processing unit 104, supports other subsystems, which form the overall system 100, including a positioning system, formed of a global positioning system 200 and a relative positioning system 400, and a 3D mapping system 600.

Global Positioning System

The positioning method performed by the global positioning system 200 is based on a sensor that creates an image of the environment, real-time identification of surfaces, and the matching of surfaces to a database that contains patterns depicting surfaces with global positional tags attached.

The concept is based on the assumption that a small swatch of surface presents a pattern that is sufficiently unique to be accurately matched, with no need for storing the surface's entire image or its features. By the nature of things, the size of the required pattern varies with the type of surface.

The disclosed methods and systems employ algorithms for filtering out the temporary elements, also known as temporal elements, of the surface—those elements that are liable to change over time, such as cracks, holes and other surface defects, stains and puddles, and elements of the surroundings, such as road signs, landmarks, trees, poles, and the like—and achieving matches according to correlation between the filtered pattern and the filtered surface.

The system of the invention can look exclusively at the ground and rely on that surface; it can look exclusively at the surroundings and rely on surfaces such as the walls of buildings, the walls of tunnels, billboards, sidewalks, a cliff, the horizon, and such; and it can integrate both the surroundings and the ground, thus maximizing the advantages of both perspectives so that the position can be pinpointed even in difficult conditions, such as when snow covers the ground, or when the surroundings are difficult to identify because they have changed, because they include no static objects, or for other reasons.

The global positioning system 200 is part of the processing unit 104 of the system 100. The global positioning system 200 includes the sensor(s) 102, which obtain images, frames, and/or the images as frames. The sensors 101 link to filters 202, which eliminate or discard elements, e.g., temporal elements (some of which are listed above), that are not permanent or may change over time. There is also the local database 105, in which patterns, that were collected in advance and include positional tagging, are stored.

A pattern selector 204 obtains a global position that was estimated on the basis of the positional tags, and retrieves pattern options belonging to the vicinity (area) of the estimated location. The pattern selector 204 performs this by sending a request for patterns at a given location (e.g., global position), and receives the relevant patterns from the local database 105. Should a central database 106 be present, the pattern selector 204 sends its request for patterns at a given location (e.g., global position), and receives the relevant patterns from the central database 106.

A matching and position finding module 205 receives the filtered frames (from images taken by the sensors 102), together with the retrieved pattern options. The module 205 performs perspective warps, rotations, and cross-correlations, in order to discern any match. If the module 305 finds a sufficiently trustworthy match, then the place of the pattern in the frame, together with the positional tag of the pattern, makes it possible for the exact global position to be calculated and passed to the vehicle's global position estimator 206. The global position estimator 206 provides an estimated global position for the system 100, this estimated global position being data input to the pattern selector 204.

The filter 202, integrated into this system 200, eliminates elements that may change over time, such as the aforementioned temporal elements. The type of surface determines the type of filter required. Such a filter 200 includes, for example, a filtration mechanism for image processing and elimination of the effects of shadow and light, relying on histograms and other systems; and it may also include machine learning methods for filtering based on running a neural network on a large set of labeled pictures.

On various types of surfaces, various algorithms can be run that are suited to the given type of surface, with information on the anticipated type of surface being received from the pattern selector module according to tagged information from the databases 105,106.

For example, an asphalt surface requires finding a description of the asphalt pebbles, including their structure, their position, and the relation between the pebbles. Temporary elements must be screened out that could alter the surface, such as the influence of light and shadows, stains and discoloration, such as oil stains and moisture, and cracks and other surface defects.

The filter 202, for example, includes the use of Canny edge detection or other edge detection, identification of the asphalt pebbles' size, screening out edges that imply objects larger than the pebbles, and screening out the influence of light and shadows.

The pattern selector module 204 receives the estimated global position of the vehicle 101 and searches the list of positional tags associated with patterns in the vehicle's database (e.g., local database 105). If the pattern selector module 204 finds patterns that are in the vicinity of the estimated position, it retrieves the pattern options from the database 105 together with accompanying information such as the positional tag and the type of surface. The information is passed to the matching and position-finding module 205.

According to the positional precision, the matching and position finding module 205 snips the filtered frame around the estimated area of the pattern and the snipped image's perspective is warped into a top view or side view. The module 205 then performs a cross-correlation on the warped sample of the frame in order to find the maximum match to the pattern. Another output of this kind of correlation, besides the matching coefficient, is a measure of similarity indicating the degree of the solution's obviousness, or the degree to which other identical solutions may be found in the search area. Cross-correlation may be performed, for example, on an intensity map, on a binary map of boundary lines (such as edges), or on a map of frequencies, for example, by fast Fourier transform (FFT). In addition, correlation may be performed on the differences between objects with respect to various measures of matching (AND, OR) and more. The method of correlation should be adjusted according to whatever is found to be the most suitable for the required type of surface.

The method of correlation is advantageous, as it: 1) simplifies calculations, for example from a general method of extracting and searching features; 2) improves the filtering of temporary elements (temporal elements), such as cracks, holes stains and other surface defects, which are subject to rapid change, in addition to filtering that has already been performed on the basis of matching the entire pattern where the temporary elements not being filtered have less impact, and 3) has the ability to reflect the actual level of reliability by finding the “uniqueness” of the solution.

If the reliability metrics are satisfactory regarding the correlation that has been found, the location of the pattern in the frame can be calculated and, on the basis of the pattern's positional tag and the camera parameters (intrinsic and extrinsic), the position of the vehicle 101 can be calculated.

The global position estimator module 206 estimates the global position of the system 100 of the vehicle 101 on the basis of all the information the system possesses, and passes that information onward for the system that retrieves patterns from the database. This position may be, for example, the initial position of the system 100/vehicle 101. This module 206, receives the global position calculated by the matching and position-finding module 205, and/or uses the calculation of the relative position (whether based on identification of the movement between frames, from the sensor(s) 102, or whether based on the use of other methods or sensors such as odometers and inertial sensors) for estimating the current position from the latest global positional update (e.g., by processes including dead reckoning), and/or receives the position from external position measurements, as input from an external system such as a GNSS.

Data Collection Processes

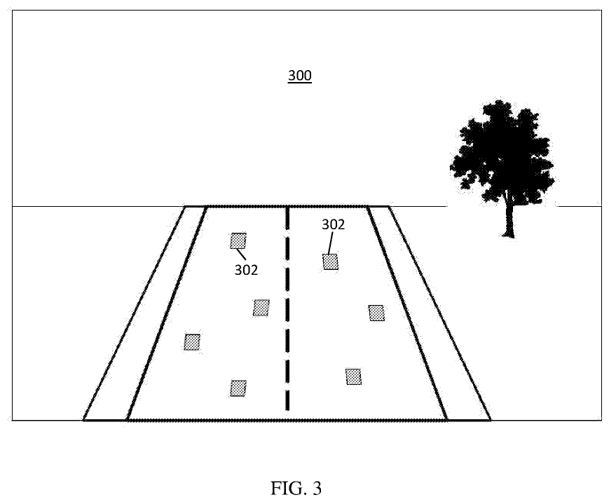

The process of obtaining and/or acquiring patterns, by the system 100, to serve as static anchors, involves the following components:
P1—Source of information—Data collection may be based on information from the vehicle in which the system is installed, or on images otherwise collected that include information about the surfaces in the road's vicinity, for example, satellite photographs or images, and aerial photographs or images collected for other purposes, such as the images of Google® Street View, light images, radar images, LIDAR images, ultrasonic images, and the like.
P2—Pattern definition—A pattern is a raster aligned to the plane of a surface and containing sufficient information about the surface. The surface may be the road surface, the walls of buildings, the walls of a tunnel, billboards, sidewalks, a cliff, or any similar flat surfaces along the route. The pattern includes, for example, a small highly detailed image portion associated with a specific location in space (as positionally tagged), as taken from an image, or in other words, the pattern is a microimage from a larger image, analogous to fingerprints, that has been sampled from various surfaces in the vicinity of the road or from the surface on which the motion (e.g., traveling of the system 100/vehicle 101) is taking place. Patterns are also known as “Road Codes” (in this document).
P3—Pattern locations—Along the route, one pattern is chosen per x meters depending on how frequently an update must be received. For patterns on the plane perpendicular to the travel route, the locations must be chosen so as to provide for dispersion of the information in order to prevent consistent disturbances that could disrupt the functioning of the algorithm The patterns could be chosen at randomly scattered positions within the vehicle's vicinity, or their positions could be selected with care. For example, on a road they could be uniformly distributed across the width of the lane—one near the left edge, one in the middle, and one near the right edge—or they could be scattered randomly across the width of the lane. The latter type of distribution enables patterns to be identified with high reliability even in cases where, at a certain point on the lane's width, a consistent disturbance occurs continuously along the lane's length—such as, for example, material spilled from a moving truck. FIG. 3 is a diagram of an image of a roadway 300 with a distribution of patterns 302, in an example distribution. While patterns 302 are shown on the roadway, the patterns can also be taken from the surroundings of the roadway, such as sidewalks, buildings, walls, trees (in limited cases), and the like.
P4—Pattern size—In the data collection process, special emphasis is placed on snipping the smallest pattern that is still unique from among the entire surface while taking the type of surface into account. For example, from an asphalt surface, as pattern size of 8×8 cm is typically the required minimum. In this way, the size of the database is reduced significantly. The smallness of the sample surface also helps reduce the burden of computation, with a small search area, based on prediction, being employed. In addition, the use of a small sample provides for increased ability to use a “smeared” image provided that the sample itself is not blurred, for example by a rolling shutter and the transitions between light and shadow which influence each area of the image differently. It is easier to filter out their influence on a small sample.
P5—The algorithmic process of creating the pattern:
   a. Aligning the image to the plane of the ground surface, top view or side view, or to the plane of the acquired pattern surface.
   b. Snipping a small part of the surface that provides a sufficiently unique sample, or to the plane of the object/surface.
   c. Running filters that are suited to the type of surface, to eliminate its temporary elements—elements liable to change over time, such as cracks, stains, etc. as detailed herein.
   d. Compressing the information, and saving it in the database together with information about the type of surface.
   e. Tagging with respect to the global position of the surface, by anchoring the information that was added (based on a precise navigational sensor or by manual anchoring, etc.).

The process of obtaining patterns to be stored in a data base, with each pattern stored with one or more global position tags (position tags), is in accordance with items P1, P2, P4 and P5 above.

The process of acquiring patterns with one or more global position tags, as the system 100 travels (e.g., along a roadway), for example, in a vehicle 101, as part of an in-vehicle system, from images from the sensor(s) 102, is in accordance with items P2, P3, P4 and P5 above. This acquisition of patterns is, for example, performed in real time while the system 100 (e.g., in the vehicle 101) is traveling (e.g., in motion).

Description of the Process of Relative Position-Finding and of Building 3D Maps from a Camera

A. General Description

In creating a three dimensional (3D) image from a camera, the human ability to use inexpensive sensors for an understanding of the surrounding environment can be imitated. Many known methods exist for finding the depth, and therefore 3D structure, in an image. Two example methods include:
1. Stereo camera—based on two or more synchronized pictures from different cameras installed in a fixed position in relation to one another. A match is sought between the pixels in one picture and the pictures from the other, along a line stretching between the two cameras. In most applications the two synchronized cameras, like the human eyes, occupy the same horizontal axis.
2. Structure from motion—a process of identifying features in overlapping frames that were acquired from the same camera during movement, and understanding about the camera's movement and the 3D positions of the features by means of analyzing the features. For example, an 8-point model (or N point model, where N is greater than 3) is used, in which mathematical calculations can determine, with good probability, the position of eight points in one frame as against eight corresponding points in the other frame. This process is computationally complex. Generally, it attempts to match features not all of which can be matched and most of which cannot be matched unmistakably. The number of features determines the complexity of the solution process, so that generally in real-time systems the quantity of information is limited (creating 3D in a sparser form). In addition, under this method performance is reduced in any very dynamic environment that disrupts the correctness of the model.

For the system 100 of the present invention, it is assumed that the vehicle 101 is moving on the surface. On the basis of accurate analysis of the relative movement in relation to the surface, each frame can be tagged with relative positional tags. The algorithmic concept mentioned earlier, based on small patterns, will be used for analyzing movement, with an emphasis on the travel surface itself This process is efficient and simple from the calculation standpoint, and it provides a highly accurate solution.

With the relative positioning solution, the process of identifying 3D from the features/pixels can be simplified while degrees of freedom are neutralized, thus creating a reliable 3D solution with the benefits of computational simplicity, denser data (with no uncertainty regarding the degree of freedom in positioning), and the ability to rely on a single camera.

Finding the relative position in this way provides a further advantage in that, because it measures the vehicle's actual movement on the surface and is not based on odometry attached to the wheels, it can help in identifying skids, and as additional input to the navigational filter it can help improve that filter's results.

B. Relative Position System

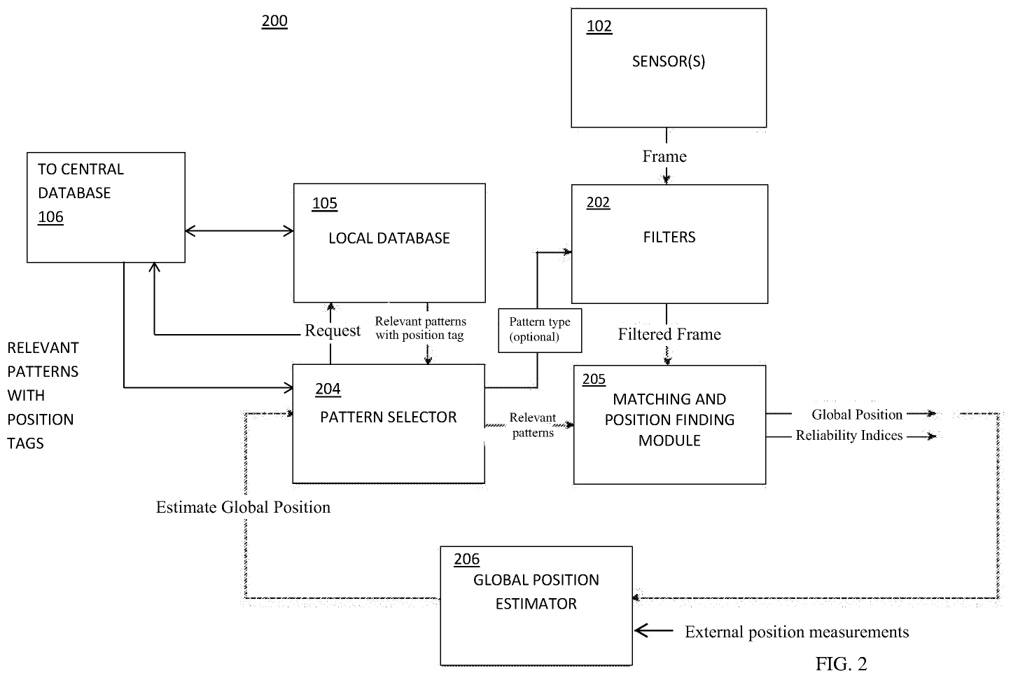

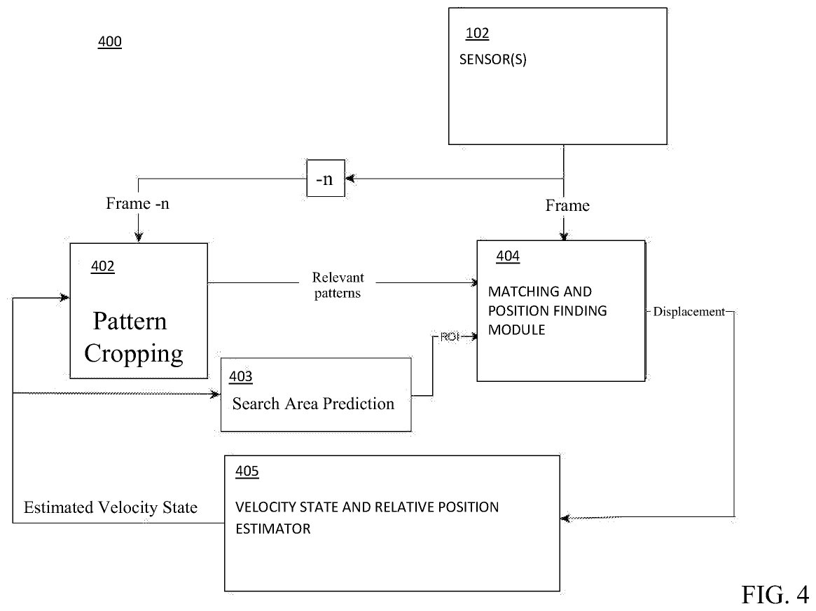

In FIG. 4, the system 400 for determining relative position includes sensor(s) 102 which capture images in frames. A previous frame (“−n”) is input (from the sensor(s) 102) into pattern cropping module 402, which selects (by cropping) portions of the image to be the patterns. A search area prediction module 403 selects a region of interest (ROI) in the current frame of the image to predict where the pattern is expected to appear in the current frame, as well as the pattern cropping module 402, provide input for the matching and position-finding module 404, which is similar to the matching and position-finding module 205, detailed above and in FIG. 2. A velocity state and relative position estimator module 405, operates to calculate the relative position of the system 100/vehicle 101, and the velocity state thereof, and provides input of the estimated velocity state of the vehicle 101 to the pattern selector module 402 and the search area prediction module 403.

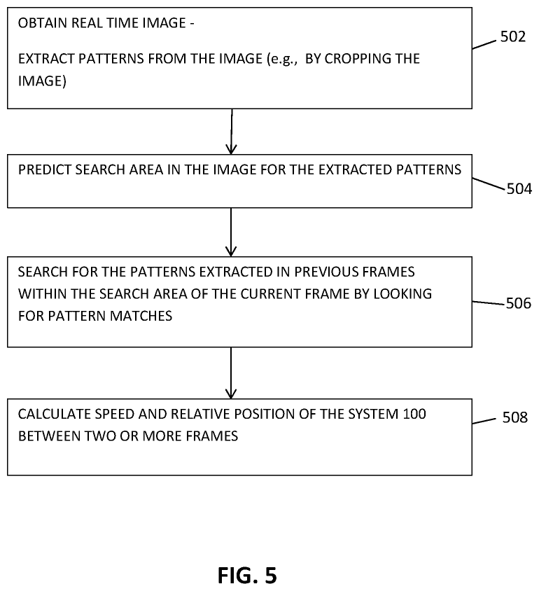

In the flow diagram of FIG. 5, the system 400 operates in a first stage, where one or more patterns are snipped from the previous frame from, for example, a real time image, by the pattern cropping module 402, at block 502. The location from which the pattern is snipped may be adaptive, as a function of the speed of travel, in order to maximize the ability to discern the movement within the frame. For example, if the movement is from right to left in the frame, at a low speed, the pattern should be chosen from the central part of the frame, but as the speed becomes greater, the pattern should be chosen farther and farther to the right of the center of the frame. The pattern should be aligned to the travel surface. Use of further patterns from scattered locations can strengthen the solution but they increase the computational complexity (in nearly direct proportion to number of patterns).

Afterward, at block 504, the area of the current frame where the pattern may be expected to appear is predicted by the search area prediction module 403. The search area is delineated around that prediction, with a size taking into account the prediction's margin of error, the range of the vehicle's possible acceleration, etc.

In the final stage, at block 506, a search for the pattern(s) focuses on the likely region in the current frame after it has been aligned to the travel surface in accordance with the predicted movement, as determined by the matching and position finding module 404. The search is based on rotation and cross-correlation, and it provides information about the quality of the match and about its uniqueness (similarity).

The process moves to block 508, where speed (velocity) is calculated, by analyzing two or more frames, according to prior calibration of the camera's (sensor's 102) parameters (intrinsic and extrinsic), by the velocity state and relative position estimator module 405.

C. The Process of Calculating 3D Maps

As a result of the finding of the relative position, two or more overlapping frames have precise relative positional tagging. As explained above, computation in 3D requires searching in one frame for a pixel/feature from another frame.

With knowledge of the exact offset in position between the overlapping frames, the search and match for the pixel/feature can be simplified, following the line that a projection of the pattern cuts between the overlapping frames. This line is a section based on knowledge of the camera model, the intrinsic parameters, and the relative position between the frames from the previous stage. The projected line defines the locations where the pixel/feature from one frame may possibly be found in the other frame, with the location along the line depending on the distance of the object from the camera. This line is typically parabolic, depending on the camera model and the position offset.

Rather than searching the entire frame, it is possible to search inside an area limited to the projected line, thus improving the process's efficiency and avoiding uncertainties that could rule out successful identification. In addition, since the range possibilities for building 3D in the application are limited, the search along the projected line will be small in scale, thus becoming quite efficient. The reduction of range makes this method particularly efficient as compared to the structure-from-motion method, where the calculations cannot be reduced because it is still necessary to check feature matches in the entire frame in order to ensure that the feature matching is correct, and does not belong to a more distant object.

An algorithm for calculating distance by use of this capability of locating the pattern's line of projection between the frames could, for example, run a correlation between pixels along the pattern projection line between the frames and use existing algorithms from the realm of stereo vision, such as correlation for identifying matches and completing context. The result of a good match is a distance in pixels.

Another example of using this ability is isolating features: searching for matches between features along the projection line between overlapping frames (not necessarily only two frames). In this way the complexity is linear rather than exponential. The result is a distance in pixels between a given feature in one frame and the same feature in another frame.

In both examples, use of the known difference in location between the frames, and knowledge of the camera's intrinsic parameters, make the distance in pixels translatable into a physical distance by correction of distortion and triangulation.

3D Mapping System

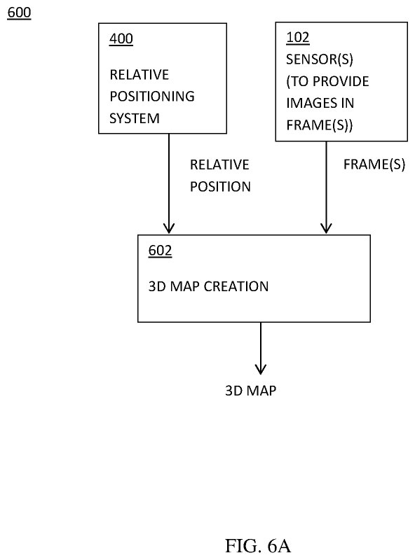

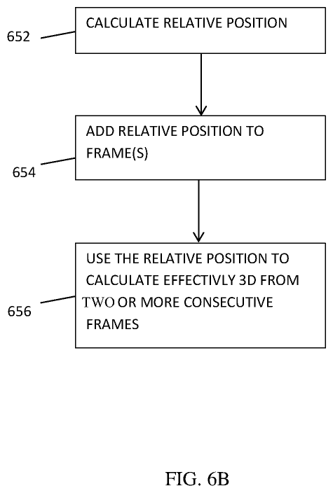

A three dimensional (3D) mapping system 600 is shown in FIG. 6A. This mapping system 600 is formed by the relative position determining system 400, as detailed above and shown in FIG. 4 and the sensor(s) 102. A 3D map creation module 602 creates a 3D map, by knowing the exact position of between the frames when the frames were captured by the sensor 102. The frame positions were provided by the relative position system 400.

The method for 3D map creation is shown in the flow diagram of FIG. 6B. At block 652, the relative position system 400 calculates relative positions. At block 654 the calculated relative positions are added to the frames being evaluated for the 3D map. The process moves to block 656, where the relative positions of the frames, for example, two or more consecutive frames are used to calculate the 3D map in accordance with that detailed in the section entitled: “Description of the process of relative position-finding and of building 3D maps from a camera”, detailed above.

System Operation

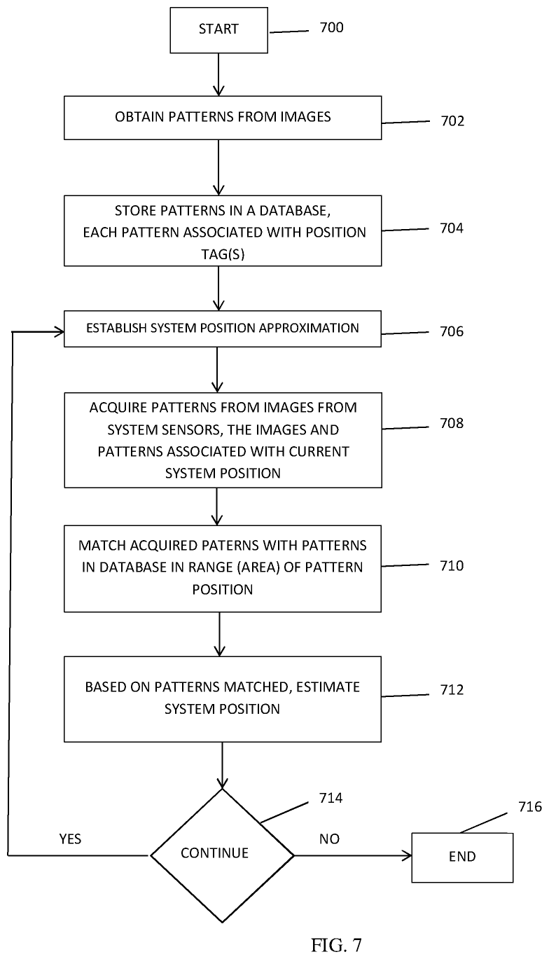

FIG. 7 is a flow diagram detailing an example process performed by the system 100 including its subsystems 200, 400, 600. Initially, the process begins at a START block 700.

The process moves to block 702, where patterns or “Road Codes” are obtained from images, including, for example, camera images, light images, radar images, LIDAR images, satellite images, and the like, which have been previously obtained. For example, the previously obtained images may be from, and were taken by outside sources or entities, such as third parties, not associated with the system 100 and/or the vehicle 101, such as street view images from Google® Streetview™, Satellite images from satellite image providers including governmental authorities, and the like. The patterns, are, for example, associated with a position as each pattern is positionally tagged (with typically one, but may be more than one, positional tag) upon their creation, either contemporaneously or simultaneously, as detailed in P1-P5 above.

The process moves to block 704, where the patterns and their positional tags are stored in one or more storage media, e.g., databases, including databases in the cloud, so as to populate the databases. These databases include, for example, the local database 105 and/or the central database 106.

Next, the process moves to block 706, where the system 100 position, for example, in the vehicle 101 is established, for example, as an approximation. This position established as an approximation of system 100/vehicle 101 position, occurs when establishing the initial position of the system 100/vehicle 100, as well as when establishing subsequent positions of the system 100/vehicle 101. This system 100/vehicle 101 position is established by the global positioning system 200 and/or the relative position positioning system 400, both as detailed above, based on all the information the system possesses, and passes that information onward for the system 200 (e.g., module 204) that retrieves patterns from the database. For example, the global positioning system 200 receives a global position calculated by the matching and position-finding module 205, and/or alternately, can receive the position from an external system such as GNSS, cellular triangulation and other location obtaining techniques, WiFi® locations, and/or as another alternative, can use the calculation of the relative position (whether based on identification of the movement between frames, from the sensor(s) 102, or whether based on the use of other methods or sensors such as odometers and inertial sensors) for estimating the current position from the latest global positional update (e.g., dead reckoning).

Patterns (“Road Codes”) are then created and acquired, as per P2-P5 above, from images obtained by the sensor(s) 102 of the moving system 100/vehicle 101, for example, as taken in real time, as the system 100/vehicle 101 travels (moves), for example, along a roadway, at block 708. These images are associated, and, for example, tagged with, the current system 100/vehicle 101 position.

The process moves to block 710, where the created and acquired patterns (taken from the system 100/vehicle 101 as it moves) are matched with previously stored patterns (in the database(s)) based on position. The position of the system 100/vehicle 101, is, for example, a range (area) of positions, the range (area) being a position plus/minus a distance error. This positional range (area) results in a corresponding number of stored patterns being searched (for the positional range (area)) and subjected to the matching process (e.g., performed by the module 205). For example, the initial position of the system 100/vehicle 101 is, for example, a large range, as its source of information is less accurate, than in subsequent iterations (cycles). Accordingly, a large number of patterns corresponding to the positional range (area) are analyzed in the pattern matching process. As the process is iterative, the position of the system 100/vehicle 101 becomes more accurate and exact with each iteration (cycle) and the positional range (area) becomes smaller for each iteration, due to the distance error becoming smaller, resulting in fewer patterns needing to be compared with each subsequent iteration. As a result, each iteration uses fewer computer resources, than the previous iteration.

The process moves to block 712, where based on the one or more acquired patterns matching with the stored patterns (e.g., one or more pattern matches) for the determined positional range (area) for the instant (current) system100/vehicle 101 position, a position (e.g., a subsequent position) is estimated.

The process moves to block 714, where the process either continues, using the estimated subsequent position, established by the subprocess of block 712. Should the process continue (with another iteration (cycle)), for example, as the system 100/vehicle 101 is still in motion or the system 100 continues to operate, the process moves to block 706, from where it resumes, with the additional information obtained in blocks 708, 710 and 712. Otherwise, the process moves from block 714 to block 716, where it ends.

The process is such that different sources of images can be used for creating patterns, as both the obtained patterns for database storage, as per block 702 and 704, and the acquired patterns from the system sensors, of block 708.

Additionally, the processes of blocks 702 and 704 are performed, for example, by the system 100 external to the vehicle 101, while the processes of blocks 706, 708, 710, 712, 714 and 716 are performed, for example, by the system 100 in the vehicle 101.

Implementation of the device, system and/or method of embodiments of the present disclosure can involve performing or completing selected tasks manually, automatically, or a combination thereof. Moreover, according to actual instrumentation and equipment of embodiments of the device, system and/or method of embodiments of the present disclosure, several selected tasks could be implemented by hardware, by software or by firmware or by a combination thereof using an operating system.

For example, hardware for performing selected tasks according to embodiments of the present disclosure could be implemented as a chip or a circuit. As software, selected tasks according to embodiments of the invention could be implemented as a plurality of software instructions or modules, being executed by a computer using any suitable operating system. In an exemplary embodiment of the present disclosure, one or more tasks according to exemplary embodiments of the device, system and/or method as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment or implementation described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art.

1. A method of establishing a position of a system, the method comprising:
obtaining one or more first patterns, each of the first patterns associated with a position by a position tag;
establishing an approximation of the system's position;
acquiring, from one or more sensors, at least one second pattern, associated with a current position of the system; and
matching the at least one second pattern to at least one of the one or more first patterns, to determine a subsequent system position.

2. (canceled)

3. The method of claim 1, wherein the first patterns are obtained from images.

4. The method of claim 1, wherein the first patterns and the at least one second pattern are obtained from images.

5. The method of claim 4, wherein the first patterns and the at least one second pattern are from different sources associated with different entities.

6. The method of claim 1, wherein matching the at least one second pattern to at least one of the one or more first patterns comprises
applying a perspective warp on at least one pattern;
performing rotation of at least one pattern; and
performing cross-correlation between the at least one second pattern and the at least one of the one or more first patterns.

7. The method of claim 4, wherein the images are obtained from one or more of cameras, structured light devices, radar devices, LIDAR devices and ultrasonic devices.

8. The method of claim 7, wherein the images include photographs, radar images, LIDAR images and ultrasonic images.

9. The method of claim 3, wherein the images are from a plurality of viewpoints.

10. The method of claim 3, wherein the images include aerial images and satellite images.

11. The method of claim 1, additionally comprising storing the obtained plurality of first patterns in storage media.

12. The method of claim 11, wherein storing the obtained plurality of first patterns in storage media includes populating at least one database with the plurality of first patterns.

13. (canceled)

14. (canceled)

15. The method of claim 1, wherein the establishing a system position includes establishing the system position as an approximation of the system position.

16. The method of claim 1, wherein the subsequent system position is established as the system position, and wherein the method additionally comprises:
acquiring at least one second pattern proximate to the position of the system; and
matching the at least one second pattern to at least one of first patterns, to determine a subsequent system position.

17. The method of claim 7, wherein the images are filtered to remove temporal elements prior to creating the one or more first patterns and the at least one second pattern.

18. The method of claim 1, wherein the first patterns used in the matching are from a positional range corresponding to the system position.

19. (canceled)

20. A method of creating a three dimensional map of an area covered by an image, the method comprising:
calculating the relative position of at least two frames of an image based on a pattern analysis; and
applying the calculated relative positions of each of the at least two frames to extract a three dimensional map.

21. (canceled)

22. (canceled)

23. A computer usable non-transitory storage medium having a computer program embodied thereon for causing a suitable processor to establish the position of a system, by performing the steps of:
obtaining one or more first patterns, each of the first patterns associated with a position tag;
establishing an approximation of the system's position;
acquiring, from one or more sensors, at least one second pattern associated with a current position of the system; and,
matching the at least one second pattern to at least one of the one or more first patterns, to determine the system's system position.

24. (canceled)

25. (canceled)

26. The method of claim 1, wherein obtaining at least one first pattern comprises:
receiving a first image as input from at least one sensor; and
cropping at least one portion of the first image as a pattern,
And wherein acquiring at least one second pattern comprises:
receiving a subsequent image as input from at least one sensor; and
selecting a region of interest (ROI) in the subsequent image, corresponding to the predicted location of the pattern in the subsequent image.

27. The method of claim 26, further comprising estimating at least one of a velocity of the system and a relative position of the system, based on said matching.

28. The method of claim 17, further comprising snipping a filtered frame around the estimated area of the at least one second pattern; warping the snipped frame's perspective into a top view or a side view; and performing cross-correlation on the warped frame in order to find the maximal match to the at least one first pattern.
